(19) United States
(12) Patent Application Publication
(10) Pub. No.: US 2020/0119384 A1
(43) Pub. Date: Apr. 16, 2020

(54) ELECTROCHEMICAL SYSTEMS WITH PRECIPITATED REACTANTS AND RELATED METHODS

(71) Applicant: Massachusetts Institute of Technology, Cambridge, MA (US)

(72) Inventors: Yet-Ming Chiang, Weston, MA (US); Zheng Li, Blacksburg, VA (US); Liang Su, Medfield, MA (US); Menghsuan Sam Pan, Cambridge, MA (US)

(73) Assignee: Massachusetts Institute of Technology, Cambridge, MA (US)

(21) Appl. No.: 16/597,329

(22) Filed: Oct. 9, 2019

Related U.S. Application Data
(60) Provisional application No. 62/744,100, filed on Oct. 10, 2018.

(51) Int. Cl. H01M 8/18; H01M 4/96; H01M 4/58; H01M 8/22; H01M 8/08; H01M 12/08

(52) U.S. Cl. CPC H01M 8/188; H01M 4/96; H01M 12/08; H01M 8/225; H01M 8/08; H01M 4/58

(57) ABSTRACT

Electrochemical apparatuses containing electrolytes that include redox-active reactants that may be present as both a dissolved species and as a solid during a charging and/or discharging process, and related methods are generally described. The redox-active reactant may contain an active species, and the electrolyte may contain a total concentration of the active species that is greater than if the redox-active reactant were completely dissolved during an entire charging and/or discharging process. The electrochemical apparatuses described may provide relatively high energy storage capacity.

### RELATED APPLICATIONS

This application claims priority under 35 USC 119(e) to U.S. Provisional Application Ser. No. 62/744,100, filed Oct. 10, 2018, entitled “Electrochemical Systems with Precipitated Reactants and Related Methods,” which is incorporated herein by reference in its entirety for all purposes.

### GOVERNMENT SPONSORSHIP

This invention was made with Government support under Grant No. DE-AC02-06CH11357 awarded by the Department of Energy. The Government has certain rights in the invention.

### TECHNICAL FIELD

Electrochemical apparatuses and electrolytes for energy storage are generally described.

### BACKGROUND

Electrochemical apparatuses such as redox flow batteries can be used as low-cost storage systems, including for storing electricity produced by renewable energy sources at the grid scale. Increasing the volumetric capacity (e.g., Ah/L) of such electrochemical energy storage systems is a key strategy for reducing associated costs. Therefore, the development of systems and methods for increasing such volumetric capacity is desirable.

### SUMMARY

Electrochemical apparatuses containing electrolytes that include redox-active reactants that may be present as both a dissolved species and as a solid during a charging and/or discharging process, and related methods are generally described. The subject matter of the present invention involves, in some cases, interrelated products, alternative solutions to a particular problem, and/or a plurality of different uses of one or more systems and/or articles.

In one aspect, an electrochemical apparatus is described. In some embodiments, the electrochemical apparatus comprises a first electrolyte comprising a liquid solvent and a redox-active reactant. In some cases, the redox-active reactant has a reduced state and an oxidized state. In some embodiments, the redox-active reactant comprises an active species. In some embodiments, solubility of the redox-active reactant in the reduced state, and solubility of the redox-active reactant in the oxidized state are each greater than or equal to 0.1 M in the first electrolyte at room temperature (22.5° C.). In certain embodiments, during a charging process and/or a discharging process of the electrochemical apparatus that causes interconversion between the reduced state and the oxidized state of the redox-active reactant, at least 10 mole percent of the active species in the first electrolyte is present as a solid.

In another aspect, methods are described. In some cases, methods comprise charging and/or discharging the electrochemical apparatus described herein.

In some cases, methods of operating an electrochemical flow cell are described. In some embodiments, the methods comprise charging and/or discharging the electrochemical flow cell, wherein the electrochemical flow cell comprises a first electrolyte comprising an aqueous solvent and a redox-active reactant, and wherein a portion, but not all of the redox-active reactant is present as a precipitate during at least a portion of either the charging or the discharging.

In some cases, methods comprise reversibly forming a precipitate of a redox-active reactant in a first electrolyte during a charging process and/or a discharging process in an electrochemical flow cell, wherein the redox-active reactant has a reduced state and an oxidized state. In some cases, solubility of the redox-active reactant in the reduced state, and solubility of the redox-active reactant in the oxidized state are each greater than or equal to 0.1 M in the electrolyte at room temperature (22.5° C.).

In some embodiments, methods comprise cycling an electrochemical apparatus having a cell potential of at least 0.35 V and a charge capacity of at least 70 Ah/L for at least 100 charge/discharge cycles, wherein the electrochemical cell comprises a redox-active reactant. In some embodiments, a portion, but not all of the redox-active reactant is present as a precipitate during at least a portion of either the charging or the discharging.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1B depict schematic illustrations of exemplary electrochemical apparatuses, according to certain embodiments;

FIG. 2A shows a plot of costs per stored capacity for aqueous sodium polysulfide electrodes of various concentration assuming capacity utilization of Na₂S₂ to Na₂S₄, according to certain embodiments;

FIG. 2B shows a plot of volumetric capacity contour lines with respect to sulfur capacity utilization and concentration, according to certain embodiments;

FIG. 3 shows an overlay of the first cycles of aqueous polysulfide electrolytes during electrochemical cycling experiments, according to certain embodiments;

FIGS. 4A-4B show plots of solubility limits and total sulfur concentrations for various sodium polysulfides in 3M NaOH at room temperature (22.5° C.), according to certain embodiments;

FIGS. 5A-5B shows electrochemical cycling of aqueous polysulfide electrolytes with varying concentrations, according to certain embodiments;

FIG. 6 shows a plot of a voltage profile of the 5^{th} cycle of aqueous polysulfide electrolytes with varying concentrations, according to certain embodiments;

FIG. 7 shows a plot of cycling of a sodium polysulfide electrolyte and images showing the observation of the formation and dissolution of precipitated polysulfide during the cycling, according to certain embodiments;

FIG. 8 shows an X-ray diffraction (XRD) spectrum of polysulfide precipitate, according to certain embodiments;

FIGS. 9A-9B show electrochemical cycling of 8 M sulfur electrolyte with precipitates aging for 100 and 50 hours, according to certain embodiments;

FIG. 10 shows electrochemical cycling of 8 M sulfur electrolyte under different rate conditions, according to certain embodiments;

FIG. 11 shows a schematic illustration of an electrochemical apparatus containing a carbon suspension, according to certain embodiments;

FIG. 12 shows electrochemical cycling at varying carbon particle content, according to certain embodiments;

FIG. 13 shows images of carbon particles and precipitates of polysulfides, according to certain embodiments; and

FIG. 14 shows electrochemical cycling using a nickel sulfide electrode, according to certain embodiments.

### DETAILED DESCRIPTION

Electrochemical apparatuses containing electrolytes that include redox-active reactants that may be present as both a dissolved species and as a solid during a charging and/or discharging process, and related methods are generally described. The electrochemical apparatus, which may, in some but not necessarily all embodiments, comprise an electrochemical flow cell, may be used for storing energy from electricity (e.g., as a battery). In some cases, the electrochemical apparatus can be charged and/or discharged reversibly (e.g., as a rechargeable battery). In certain cases, a first electrolyte comprises a redox-active reactant (e.g., a polysulfide) having a reduced state (e.g., S₂²⁻) and an oxidized state (e.g., S₄²⁻), and the redox-active reactant comprises an active species (e.g., sulfur, S). The redox-active reactant may be present in the first electrolyte at a high enough concentration that at least a certain amount (e.g., 10 mole percent) of the redox-active reactant and/or the active species of the redox-active reactant is present as a solid (e.g., as a precipitate). The solid may be present or form during, for example, a charging process or a discharging process of the electrochemical apparatus. In conventional electrochemical apparatuses, the amount of redox-active reactant and therefore the amount of active species present is limited to that which allows both the reduced and oxidized states of the reactant to be dissolved in the electrolyte (e.g., limited by the solubility limits) during an entire cycling of the apparatus. However, the systems and methods described herein demonstrate that in certain cases, having the redox-active reactant and/or active species be present as a solid (e.g., a precipitate) during cycling can allow for the redox-active reactant and/or the active species to be present at a total concentration greater than that allowed by solubility limits, thereby providing increased volumetric capacity as compared to conventional systems, in accordance with certain embodiments. Unexpectedly, electrochemical apparatuses operating under such conditions (e.g., involving the presence of both dissolved and precipitated redox-active reactant and active species) can cycle reversibly with negligible loss in capacity over numerous cycles.

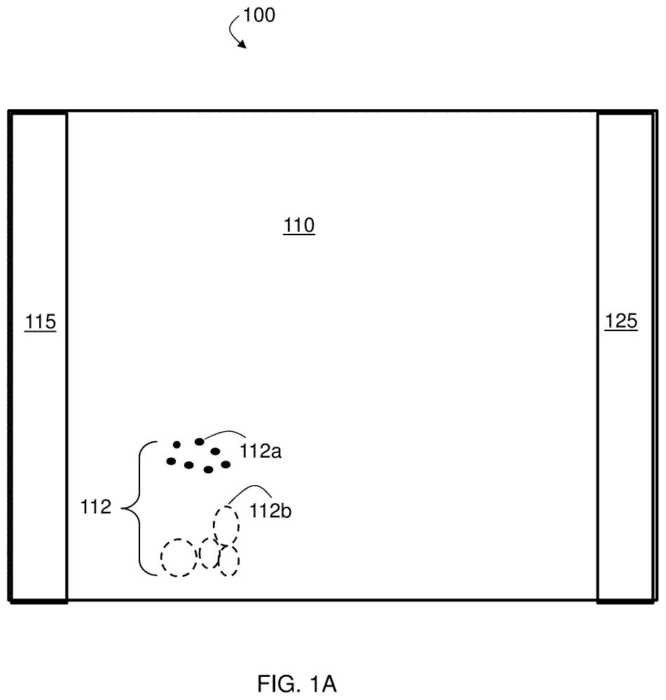

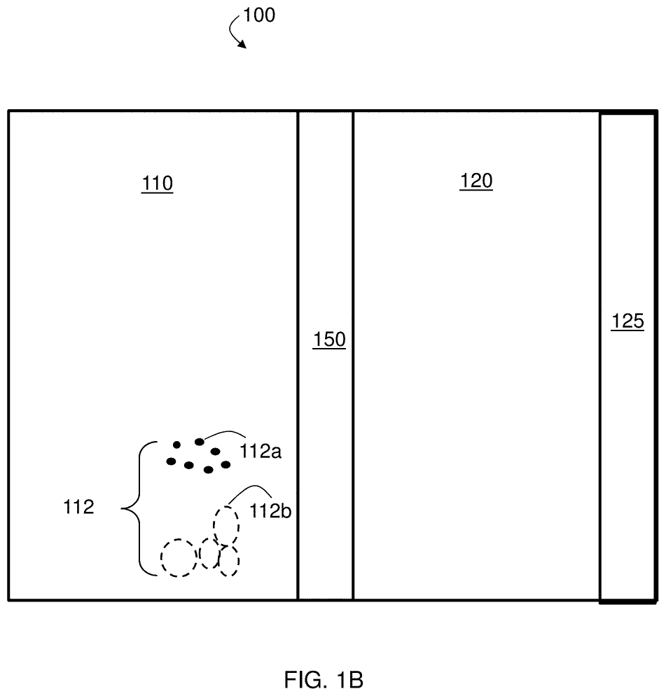

In certain embodiments, an electrochemical apparatus is provided. FIG. 1A depicts exemplary electrochemical apparatus 100, in accordance with certain embodiments. As mentioned above, in some embodiments, the electrochemical apparatus is or comprises an electrochemical cell. For example, in some embodiments, the electrochemical apparatus (e.g., electrochemical apparatus 100) is a battery (e.g., a reversible battery). In certain cases, electrochemical apparatus 100 comprises first electrolyte 110 and counter electrode 125. As mentioned above and in references incorporated herein, the electrochemical apparatus may be capable of being cycled. Cycling of the electrochemical apparatus may comprise charging the electrochemical apparatus (e.g., via the application of an external electrical potential to electrodes of the apparatus, such as from a potentiostat or from electricity from a grid). Cycling of the electrochemical cell may include discharging the electrochemical apparatus (e.g., forming an electrical circuit between at least two electrodes or current collectors and allowing an electrochemical reaction to occur). In some, but not necessarily all cases, cycling of the electrochemical apparatus includes applying and, optionally, varying an electrical potential to at least two electrodes or current collectors associated with a first electrolyte and a second electrolyte.

As mentioned above, in some embodiments, the electrochemical apparatus comprises a first electrolyte. An electrolyte generally refers a to medium that can facilitate the storage and transport of ions in an electrochemical apparatus such as a battery. At least a portion of an electrolyte is generally in contact with at least one current collector when an electrochemical apparatus is cycled. An electrolyte is generally ionically conductive. However, an electrolyte is generally electronically non-conductive to prevent short-circuiting of the electrochemical apparatus. It should be understood, however, that in some instances, one or more components of the electrolyte can undergo electron transfer reactions (e.g., a redox reaction in a redox battery). In some cases, the electrolyte is a mixture, such as a homogeneous mixture (e.g., a liquid solution) or a heterogeneous mixture (e.g., a solution within which a solid is present, such as a suspension). In some such instances, the electrolyte comprises a solvent. A solvent is generally a liquid within which other components of the electrolyte (e.g., redox-active reactants, supporting electrolyte ions, etc.) are dissolved and/or present as solids (e.g., in suspensions). The first electrolyte (e.g., first electrolyte 110 of electrochemical apparatus 100) may comprise a solvent. The solvent may be any suitable solvent for operating the electrochemical apparatus and performing electrochemical reactions involving the redox-active reactant. For a given redox-active reactant and application, one of ordinary skill, with the benefit of this disclosure, could select an appropriate solvent for an electrolyte. For example, one could determine the solubility of the redox-active reactant (e.g., from a reference database or experimentally) and assess whether the solubility is sufficient for the electrochemical apparatuses and methods described herein to be achieved. Other considerations, such as the polarity, viscosity, and/or volatility of the solvent may be taken into account. In some cases, the solvent of the first electrolyte is aqueous (e.g., comprising primarily water). In other words, in some embodiments, the first electrolyte comprises a solvent comprising primarily water. In some such cases then, the first electrolyte (e.g., first electrolyte 110) is an aqueous electrolyte. Other non-limiting examples of solvents include non-aqueous solvents such as organic liquids (e.g., tetraethylene glycol dimethyl ether, dimethoxyethane, acetonitrile, butyronitrile, trimethylphosphate, diglyme, ethanol, toluene, hexane, tetrahydrofuran, 1-propanol, ethyl acetate, N,N-dimethylformamide) or ionic liquids. In some, but not necessarily all embodiments, it may be beneficial for the first electrolyte to be aqueous, based on cost or environmental considerations. In certain cases, the aqueous solvent is at least 50 volume percent (vol %), at least 75 vol %, at least 90 vol %, at least 99 vol %, or substantially all water.

In some embodiments, the first electrolyte comprises a redox-active reactant. For example, referring again to FIG. 1A, first electrolyte 110 comprises redox-active reactant 112. A redox-active reactant may, in some cases, accept or donate charge (e.g., electrons) during a charging process and a discharging process of the electrochemical apparatus. As such, the redox-active reactant may have a reduced state (e.g., a state with a larger number of electrons) and an oxidized state (e.g., a state with a smaller number of electrons). The reduced state and the oxidized state of the redox-active reactant may be caused to interconvert, at least partially, during charging and/or discharging of the electrochemical apparatus. Any of a variety of redox-active reactants may be selected, for example, based on a desired volumetric capacity of the electrochemical apparatus, solubility, chemical compatibility, or associated costs. In some cases, the redox-active reactant comprises a sulfur-containing compound. One non-limiting example of a possible redox-active reactant is one that is or comprises a polysulfide compound. The reduced state of the polysulfide compound may, in some cases, be S₂²⁻ or a salt thereof (e.g., Na₂S₂), while the oxidized state of the polysulfide compound may, in some cases by S₄²⁻ or a salt thereof (e.g., Na₄S₂). Other non-limiting examples of redox-active reactants that may be suitable in the electrochemical apparatus described herein include those comprising vanadium (e.g., V³⁺/V²⁺), iodine (e.g., I³⁻/I⁻), titanium (e.g., Ti⁴⁺/³⁺), chromium (e.g., Cr³⁺/Cr²⁺), manganese (e.g., Mn³⁺/Mn²⁺), and/or iron (e.g., Fe³⁺/Fe²⁺). It should be understood that, generally, the solid (e.g., precipitate), described herein, when formed, may not be a metallic solid of the redox-active reactant (e.g., as in the case of a zinc metallic electrode). Indeed, the solid (e.g., precipitate) may be or comprise a nonmetallic compound. In some cases, the solid (e.g., precipitate) is an electrically insulating compound. As one example, in some cases the solid (e.g., precipitate) comprises a sulfur-containing compound, such as a polysulfide, and is a nonmetallic compound that is electronically insulating. In certain cases, the redox-active reactant is or comprises an organic compound, such as one containing an aromatic group. It should be understood that when a redox-active reactant is present in an electrolyte, it may be present in either or both of its reduced state or its oxidized state.

The redox-active reactant may comprise an active species. The active species of a redox-active reactant may be an atom, a type of atom, or a moiety of the redox-active reactant that undergoes an electron transfer process during charging and discharging processes. As such, the active species may undergo a change in oxidation state during charging and discharging processes. As one non-limiting example, the redox-active reactant may comprise sulfur as an active species. For example, in cases in which the redox-active reactant comprises a polysulfide (e.g., with Na₂S₂ as its reduced state and Na₂S₄ as its oxidized state), the active species may be sulfur. Further, a solution (e.g., an electrolyte) containing 1 M Na₂S₄ as the only sulfur-containing species, and sulfur as the active species, is considered to have an active species concentration of 4 M. That is because a solution containing 1 M Na₂S₄ contains 4 M of sulfur (referring to the atom S and not molecular sulfur) as an active species. A solution containing both 1 M Na₂S₄ and 1 M Na Na₂S₂ is considered to have an active species concentration (e.g., total sulfur concentration) of 6 M.

It may be beneficial to have a relatively high total concentration of the active species in the first electrolyte, as it may impart a relatively high volumetric capacity to the electrochemical apparatus, in accordance with certain embodiments. The total concentration of the active species or the redox-active reactant includes both the concentration of dissolved active species (e.g., sulfur in dissolved polysulfides such as S₂²⁻) as well as the active species present in any solids such as precipitates of the redox-active reactant in the volume occupied by the first electrolyte in the electrochemical apparatus. A precipitate generally refers to a solid initially formed in a solution. The total concentration of the active species or the redox-active reactant can be calculated by determining the number of moles of the active species or the redox-active reactant (both in dissolved or solid form) located in the volume occupied by the first electrolyte and dividing by that volume. As a non-limiting example, if the electrolyte occupies a volume of 6 L and contains 2 mol of the active species dissolved in the solvent of the electrolyte and 1 mol of the active species as part of a solid (e.g., precipitate), then the total concentration of that active species is 0.5 M (because 2 mol+1 mol=3 mol, and 3 mol divided by 6 L=0.5 M). In some embodiments, the total concentration of active species in the first electrolyte is greater than or equal to 0.5 M, greater than or equal to 1 M, greater than or equal to 2 M, greater than or equal to 3 M, greater than or equal to 4 M, greater than or equal to 5 M, greater than or equal to 8 M, or greater than or equal to 10 M. In certain embodiments, the total concentration of redox-active reactant is greater than or equal to 1 M, greater than or equal to 2 M, greater than or equal to 3 M, greater than or equal to 4 M, greater than or equal to 5 M, greater than or equal to 8 M, or greater than or equal to 10 M.

In some cases, the redox-active reactant has a relatively high solubility in the electrolyte (e.g., an aqueous electrolyte). The solubility of a substance at a given temperature generally refers to the maximum amount of that substance that is able to dissolved in a solvent at equilibrium at that temperature, and can be recited in units of concentration, such as molarity (M). In certain cases, both the reduced state and the oxidized state of the redox-active reactant have relatively high solubilities. For example, in some embodiments, the solubility of the redox-active reactant in the reduced state and the solubility of the redox-active reactant in the oxidized state are each greater than or equal to 0.1 M, greater than or equal to 0.2 M, greater than or equal to 0.3 M, greater than or equal to 0.4 M, greater than or equal to 0.5 M, greater than or equal to 1 M, greater than or equal to 2 M, and/or up to 5 M, up to 10 M, up to 15 M, or more in the electrolyte at room temperature. Room temperature herein generally refers to 22.5° C. In certain cases, the reduced state of the redox-active reactant and the oxidized state of the redox-active reactant have different solubilities in the electrolyte. For example, in some embodiments, the ratio of the solubility of the reduced state of the redox-active reactant to that of the oxidized state may be greater than or equal to 1/100, greater than or equal to 1/10, greater than or equal to 1, greater than or equal to 10, and/or up to 100 or more. Having relatively different solubilities between the reduced state and the oxidized state may result in a portion of the redox-active reactant precipitating (e.g., forming a solid) during a charging and/or a discharging process. For example, Na₂S₄ has a significantly greater solubility in water than does Na₂S₂. Therefore, reduction of a first electrolyte comprising a relatively high concentration of dissolved Na₂S₄ (e.g., during a charging process or a discharging process) may result in the formation of a concentration of Na₂S₂ in the electrolyte that is above the solubility limit for Na₂S₂. In some such cases, such a charging and/or discharging of the electrochemical apparatus may result in the formation of a precipitate comprising solid Na₂S₂. During an oxidation process, at least a portion of the precipitate containing the Na₂S₂ may re-dissolve as it is converted back to the Na₂S₄ having a higher solubility.

In some embodiments, during a charging process and/or a discharging process of the electrochemical apparatus that causes interconversion between a reduced state and an oxidized state of the redox-active apparatus, a relatively high portion of the active species is present in the first electrolyte as a solid (e.g., as a precipitate). In some cases, a certain portion of the redox-active reactant remains in solution during the charging process. Referring again to FIG. 1A, first electrolyte 110 comprises redox-active reactant 112, and a portion of redox-active reactant 112 is present in first electrolyte 110 as dissolved redox-active reactant 112a, and a portion of redox-active reactant 112 is present in first electrolyte 110 as solid redox-active reactant 112b during a charging and/or discharging process of electrochemical apparatus 100, according to certain embodiments. In some cases, at least 10 mole percent, at least 20 mole percent, greater than or equal to 35 mole percent, greater than or equal to 50 mole percent, greater than or equal to 65 mole percent, greater than or equal to 80 mole percent, or greater than or equal to 90 mole percent of the active species is present in the first electrolyte as a solid during the charging process and/or the discharging process. Having at least a portion, but not necessarily all of the redox-active reactant and consequently the active species present as a solid during a charging or a discharging process may provide advantages over conventional systems, in accordance with certain embodiments. For example, in conventional cases in which both reduced state and the oxidized state of an exemplary redox-active reactant remains dissolved in solution during an entire cycling process, the total concentration of the active species may be limited to, for example 5 M. However, in cases described herein in which the solubility limits are surpassed and at least a portion of the active species is present as a solid (e.g., a precipitate) during cycling, a total concentration of the active species of greater than 5 M (e.g., 6 M, 8 M, 10 M) may be achievable, thereby increasing volumetric capacity. In some cases, the electrochemical cell may have a volumetric capacity of at least 70 Ah/L, at least 80 Ah/L, at least 100 Ah/L, or more.

In some cases, the electrochemical apparatus may be charged and discharged reversibly. For example, an electrochemical apparatus may by charged and discharged reversibly by having an initial state of charge, then being discharged to a relatively low state of charge (e.g., less than 50%, less than 30%, less than 20%, less than 10% or less relative to the initial state of charge), and then being charged to a relatively high percentage of the initial state of charge (e.g., greater than or equal to 80%, greater than or equal to 90%, greater than or equal to 95%, greater than or equal to 98%, greater than or equal to 99%, or substantially 100% of the initial state of charge). In certain cases, the electrochemical apparatus may continue to operate (e.g., cycling, including cycling reversibly) without significant loss in capacity even with precipitate present (e.g., the electrochemical apparatus retains up to 80%, up to 90%, up to 95%, up to 98%, up to 99%, or substantially 100% of the volumetric capacity after at least 100 cycles, at least 200 cycles, at least 500 cycles, or more).

In some cases, less than or equal to 90 mole percent, less than or equal 80 mole percent, less than or equal to 65 mole percent, less than or equal to 50 mole percent, less than or equal or equal to 35 mole percent, less than or equal to 20 mole percent, or less than or equal to 10 mole percent of the active species is dissolved in the solvent of the first electrolyte during the charging process and/or the discharging process.

The redox reaction that takes place in the first electrolyte during a charging process or a discharging process may vary, depending upon the conditions of the cycling (e.g., the type of material used as a counter electrode, the polarization applied to a counter electrode, etc.). In some embodiments, the first electrolyte is an anolyte. Referring to FIG. 1A, in some embodiments, first electrolyte 110 is an anolyte. For example, in some cases, during discharging of the electrochemical apparatus, the redox-active reactant is converted from its reduced state to its oxidized state (with the opposite reaction occurring during charging). For example, in some cases, the electrochemical apparatus comprises a polysulfide redox-active reactant in the first electrolyte, and the first electrolyte is an anolyte, with the polysulfide being oxidized during discharge of the apparatus. In some embodiments, the first electrolyte is a catholyte. For example, in some cases, during discharging of the electrochemical apparatus, the redox-active reactant is converted from its oxidized state to its reduced state (with the opposite reaction occurring during charging).

In some embodiments, discharging and/or charging the electrochemical apparatus occurs at a certain rate. For example, in some applications, a relatively fast cycling rate is desired, while in others, a relatively slow cycling rate is used (e.g., for long duration energy storage). The discharging and/or charging may occur with a current density of at least 0.001 mA/cm², 0.01 mA/cm², at least 0.1 mA/cm², at least 1.0 mA/cm² and/or up to 5.0 mA/cm². The electrochemical apparatus may, in certain cases, be cycled with C-rates of at least C/100, at least C/50, at least C/40, at least C/30, at least C/20, at least C/10, at least C/5, at least C/2, at least C1, at least C2, at least C10, at least C5 or higher. It is well-known that a C-rate generally refers to a measure of the rate at which an electrochemical apparatus (e.g., battery) is discharged relative to its maximum capacity. A C-rate of C1 refers to a rate that results in the discharge of an entire electrochemical apparatus in one hour. Other C-rates can be expressed relative to the C1 rate. For example, a C-rate of C2 is twice as high as C1, with a C2 rate resulting in the discharge of an entire electrochemical apparatus in 30 minutes. As another example, a C-rate of C/2 is half has as high as C1, with a C/2 rate resulting in the discharge of an entire electrochemical apparatus in 2 hours.

In some embodiments, the electrochemical apparatus comprises a counter electrode. For example, referring to FIG. 1A, electrochemical apparatus 100 comprises counter electrode 125, according to certain embodiments. In some cases, the first electrolyte is an anolyte and the counter electrode is a cathode. In some cases, the first electrolyte is a catholyte and the counter electrode is an anode. The counter electrode, in certain cases, may comprise any of a variety of suitable materials, as would be recognized by a person of ordinary skill in the art with the benefit of this disclosure. For example, the counter electrode may comprise an electronically conductive solid (e.g., a transition metal or transition metal alloy such as stainless steel, gold, platinum, silver, copper, aluminum) or other conductive materials, such as those containing carbon (e.g., carbon nanoparticles, carbon rods or disks, carbon nanotubes, graphite, and the like). In some embodiments, the counter electrode serves as a current collector (e.g., the counter electrode comprises an electronically conductive solid that is not redox active). However, in some embodiments, the counter electrode is a redox-active solid that undergoes oxidation and reduction during cycling of the electrochemical apparatus and thereby store electrical charge. In some embodiments, the counter electrode is an intercalation compound. In some embodiments, the counter electrode comprises an alkali metal, alkali metal alloy, or an alkali ion intercalation compound, where the alkali metal may be Li, Na, or K. In some cases, the counter electrode comprises lithium, a lithium alloy, or a lithium intercalation compound.

In some, but not necessarily all embodiments, the electrochemical apparatus comprises a second electrolyte in contact with the counter electrode. Referring to FIG. 1B, electrochemical cell 100 comprises second electrolyte 120 in contact with counter electrode 125, according to certain embodiments. The second electrolyte may comprise a liquid solvent (e.g., an aqueous electrolyte, a non-aqueous electrolyte, an ionic liquid, etc.). In cases in which the first electrolyte (e.g., electrolyte 110) is an anolyte, the second electrolyte may be a catholyte. In cases in which the first electrolyte is a catholyte, the second electrolyte may be an anolyte. The second electrolyte may comprise a redox-active reactant. In certain cases, the redox-active reactant of the second electrolyte is the same as the redox-active reactant of the first electrolyte. However, in some embodiments, the redox-active reactant of the second electrolyte is different than that of the first electrolyte. In some cases, the electrochemical apparatus is configured such that oxygen gas is evolved at the counter electrode and/or in the second electrolyte during a charging process and/or oxygen gas is converted to water in the second electrolyte during a discharging process. For example, in FIG. 1B, electrochemical cell 100 may be configured such that oxygen gas is evolved at counter electrode 125 and/or in second electrolyte 120 during a charging process, and oxygen gas is converted to water in second electrolyte 120 during a discharging process. Some such embodiments may, in accordance with certain embodiments, be useful due to potentially high volumetric and/or gravimetric capacities and energy densities. In some cases, the first electrolyte comprises an anolyte comprising a polysulfide redox-active reactant and the catholyte is configured to evolve oxygen gas/convert oxygen gas to water as described above.

The choice of the counter electrode and/or a redox-active reactant in the second electrolyte may determine, at least in part, the cell potential of the electrochemical apparatus. In some cases, the electrochemical apparatus is configured to have a cell potential during cycling of at least 0.35 V, at least 0.4 V, at least 0.5 V, at least 0.8 V, at least 1.0 V, at least 1.2 V, and/or up to 1.5 V, up to 1.8 V, up to 2.0 V, or more.

In some, but not necessarily all embodiments, the electrochemical apparatus comprises a separator. For example, FIG. 1B shows exemplary electrochemical apparatus 100 comprising separator 150. In certain cases, the separator at least partially separates the first electrolyte from the counter electrode and/or the second electrolyte. A person of ordinary skill, with the benefit of this disclosure, will be able to select a suitable separator. For example, the separator may comprise a membrane (e.g., an membrane permeable to certain, but not all ions). The separator may comprises a porous solid material. In some instances, the separator is chosen based on the composition of one or more of the first electrolyte and, when present, the second electrolyte. For example, in some embodiments, it is desired for counter-cations in the first electrolyte (e.g. alkali metal ion) to pass through the separator during a charging and/or discharge. In some such embodiments, a separator is chosen to be permeable (beyond mere leakage) to that counter-cation when in contact with the first electrolyte. The separator may be a lithium-conducting material (e.g., a LISICON) or a sodium-conducting material (e.g., a NASICON), or a potassium-conducting material (e.g., a K-beta alumina) according to certain embodiments.

In some embodiments, the electrochemical apparatus comprises a first electrode in contact with the first electrolyte. Referring to FIG. 1A, electrochemical apparatus 100 comprises first electrode 115 in contact with first electrolyte 110. As described above for the second electrode, the first electrode may comprise any of a number of suitable materials (e.g., the conductive solids described above, such as stainless steel). The first electrode may, in some cases, serve primarily as a current collector to transfer electrons to and/or from the redox-active reactant. In certain embodiments, however, the first electrode may be or comprise a material selected such that an overpotential for the interconversion between the reduced state and the oxidized state of the redox-active material is reduced. For example, in some cases, the first electrode comprises a suspension of conductive particles. The suspension of conductive material may be suspended in the first electrolyte in some cases. As an example, in some cases, at least a portion of first electrode 115 in FIGS. 1A-1B is suspended in first electrolyte 110. In some embodiments, the suspension of conductive material allows precipitation of the solid to be spatially distributed throughout the conductive suspension, wherever electron transfer may take place. In some such instances the overpotential for interconversion may be reduced, and the reversible capacity of the electrode may be increased. In some embodiments, the suspension of conductive particles comprises carbon. For example, the first electrode may comprise Vulcan XC 72R.

In some cases, the first electrode comprises an electrocatalytic material. The electrocatalytic material may capable of catalyzing conversion of the reduced state and the oxidized state of the redox-active reactant during cycling of the electrochemical apparatus, resulting in a lower overpotential than other materials, such as planar stainless steel. In some cases, the electrocatalyst may be a transition metal solid. In some cases, the electrocatalyst contains nickel. In some such cases, the first electrode comprises a nickel sulfide electrocatalyst capable of catalyzing interconversion between polysulfides.

In some embodiments, the electrochemical apparatus may be configured to operate as a flow battery cell. For example, the electrochemical apparatus may comprise chambers (e.g., a chamber containing the first electrolyte separated at least partially via a separator from a chamber containing the second electrolyte), as well as inlets, outlets, pumps, and/or valves. The electrochemical apparatus may be configured to flow the first electrolyte (e.g., through a chamber and/or past the separator) during a charging process and/or a discharging process. In certain cases, at least a portion of the active species in the first electrolyte is present as a solid (e.g., a precipitate) during the flowing of the first electrolyte. Referring again to FIGS. 1A-1B, electrochemical apparatus 100 in FIGS. 1A-1B is configured to operate as a flow battery cell, according to some but not necessarily all embodiments.

U.S. Provisional Application No. 62/744,100, filed Oct. 10, 2018, entitled “Electrochemical Systems with Precipitated Reactants and Related Methods,” and International Patent Application Publication No. WO 2017/075577 (International Patent Application No. PCT/US2016/059692), filed Oct. 31, 2016, and entitled “Air-Breathing Aqueous Sulfur Rechargeable Batteries,” are each incorporated herein by reference in their entirety for all purposes.

The following examples are intended to illustrate certain embodiments of the present invention, but do not exemplify the full scope of the invention.

### Example 1

This example describes experimentation, embodiments, and non-limiting theories regarding the mechanisms and parameters guiding the electrochemical apparatuses, electrolytes, and methods described herein. The materials and parameter values described in this example are non-limiting and by way of example, only.

### Experimental

### Preparation of Aqueous Sodium Polysulfide Solutions

To preserve the integrity of air sensitive chemicals, sodium sulfide anhydrous (Na₂S, ≥95%, Alfa Aesar) and sulfur (S, ≥99.5%, Alfa Aesar) were dried under vacuum overnight and stored in an Ar-filled glovebox (dry glovebox) with O₂ and H₂O levels below 0.1 ppm. Sodium hydroxide pellets (NaOH, ≥98%, Alfa Aesar) were placed under vacuum overnight and stored in an Ar-filled wet glovebox. Aqueous Na₂S₄ solutions of various concentrations were prepared with the following steps. First, 3M NaOH was dissolved into deionized water in the wet box. All aqueous polysulfide solutions used in this work, thus included 3M NaOH as the supporting electrolyte; in the remainder of this example, the 3M NaOH supporting electrolyte are frequently omitted in the descriptions. Second, stoichiometric amounts of Na₂S and S in 1:3 molar ratio were transferred within a sealed bottle from the dry glovebox into the wet glovebox. Third, the Na₂S and S powders were dissolved into the prepared 3M NaOH solutions. The resulting solutions were stirred using magnetic stirrers until all powders fully dissolved. Aqueous sodium polysulfide solutions were stored and used in the wet glovebox to prevent polysulfide oxidation by O₂; therefore, all cell assemblies described onward were performed in the wet glovebox.

### Long Duration Galvanostatic Cycling of Aqueous Polysulfide Electrodes

Modified low-volume H-cells for long duration cycling were designed to cycle the sodium polysulfide electrodes. To eliminate water crossover, sodium-ion ceramic conductors, NASICONs (Ceramatec, Salt Lake City, Utah, USA), were utilized to separate the working and counter electrodes. For some fully soluble electrode cycling experiments, Nafion® perfluorinated membranes (Nafion®117, 0.007″ thickness, Sigma Aldrich) were used in place of NASICONs. In all experiments, 200 L of the desired concentration Na₂S₄ solutions were loaded into the low-volume side of the cells as the working electrodes, while 5 mL of 2M Na₂S₄ solutions were used as the counter electrodes. Stainless steel 316 meshes (Alfa Aesar) was used as the current collectors on both sides of the cell. For all long duration cycling experiments, current of 1 mA, or 0.79 mA/cm²_{membrane}, was used during charging and discharging with capacity cutoffs corresponding to sulfur state of charge (SOC) swings between the desired ranges, while voltage was measured between the low-volume working electrode and a Pt wire (≥99%, Alfa Aesar) immersed in the counter electrode as the pseudo-reference electrode. Moreover, a cell of the same construction with 10 initial forming cycles was tested under various C-rates and thus, current density to understand the precipitation behavior of sodium polysulfide subjected different rate conditions. All electrochemical tests here were performed on Bio-Logic VMP3 potentiostat (Bio-Logic Science Instruments, Seyssinet-Pariset, France).

### Sodium Polysulfide Solubility Measurements in Alkaline Media

Excess amounts of Na₂S and S with desired stoichiometric ratios (specifically, 1:0, 1:1, 1:2, 1:3, and 1:4 to obtain Na₂S, Na₂S₂, Na₂S₃, Na₂S₄, and Na₂S₅, nominally) along with sodium hydroxide powders (NaOH, ≥98%, Alfa Aesar), were mixed with deionized water to obtain 10 mL of oversaturated sodium polysulfide and 3M NaOH solutions in the wet glovebox. The oxidation states of sodium polysulfide electrolytes are calculated “nominally” since aqueous sodium polysulfide solutions involves a complex chemical equilibrium among many species including Na⁺, OH⁻, HS⁻, S²⁻, Sₓ²⁻, and so on. The initial solutions were stirred with magnetic stirrers for 24 hours before adding 0.1 mL of 3M NaOH every 24 hours while stirring until all solids were fully dissolved. The solubility of sodium polysulfide in 3M NaOH was then calculated using the amounts of Na₂S and sulfur measured initially and the volumes of the final fully dissolved solutions. The solubility measurements were performed three times with average values and maximum deviations from the averages as the error bars reported. Throughout the experiments, the temperature inside the wet glovebox was periodically monitored and found to fluctuate insignificantly around 22.5° C.

### Polysulfide Precipitation Observations and Characterizations Using X-Ray Photoelectron Spectroscopy (XPS)

A modified H-cell, equipped with a working electrode (WE), reference electrode (RE), and counter electrode (CE) was used for precipitation observation and analysis. The modified H-cell included the WE in a first compartment that was separated from a second compartment by a separator. The second compartment contained the RE and the CE. Compared to the low-volume cell, the observable cell was designed with the capability for directly observing precipitations and dissolutions as well as generating enough sodium polysulfide precipitates for SEM and XPS. 2.5 mL of 2M Na₂S₄ solutions were loaded into the modified side of the cells as the working electrodes, while the counter electrodes and reference electrodes composed of same components as that of long duration cycling experiments. 2.5 mA, or 1.97 mA/cm²_{membrane} was applied, or C/106 for one cycle, which corresponds to SOC swings between Na₂S₄ and Na₂S₂, while voltage was measured between the working electrode and the Pt pseudo-reference electrode using a Solartron 1470E Potentiostat (Ametek Scientific Instruments, Berwyn, Pa., USA). Photos of the working electrode were taken once a day.

Several experiments using the same setup were performed with the precipitate formed during the reduction step processed for analysis. After the reduction step, the cells were disassembled in the wet glovebox to extract the polysulfide precipitates. Excess solutions were removed by setting the precipitates on a filter paper (VWR International) for 20 minutes and then in vacuum for 5 hours. As the XPS sample, the dried precipitates were milled into powders using agate pestle and mortar in a glovebox (dry), and then further dried under vacuum overnight. Since XPS is a surface analysis technique, milling helps in obtaining chemical information from the bulk precipitates. The powders were then transferred into a Versaprobe II X-ray Photoelectron Spectrometer (Physical Electronics, Chanhassen, Minn., USA) using an Ar-filled transfer vessel for XPS analysis. The spectrometer used a monochromatic Al Kα X-ray source with 200 μm beam diameter and 49.3 W of X-ray power, and a dual-beam neutralizer to prevent charging effect. The obtained XPS spectra were calibrated, fitted, and quantified using CasaXPS (Casa Software Ltd, Wilmslow, Cheshire, UK) software. The spectra were charge corrected by shifting the adventitious C 1s peak to 284.0 eV and background subtracted using a Shirley background.

### Example 2

This example describes further experimentation, embodiments, and non-limiting theories regarding the mechanisms and parameters guiding the electrochemical apparatuses, electrolytes, and methods described herein. The materials and parameter values described in this example are non-limiting and by way of example, only.

### Introduction

The levelized costs of electricity (LCOE) for wind and solar electricity generation have recently dropped to a level nearly competitive with that of fossil fuels, making the needs for energy storage more pressing. Accordingly, low-cost energy storage systems are required for the deeper market penetration of these intermittent renewable energy sources. Emerging use case studies reveal the requirement for installed costs of <$50/kWh. Today, pumped hydroelectric storage (PHS) dominates the large-scale energy storage market due to its low cost and high technological readiness level; however, PHS faces geographic and environmental constraints that prevent its widespread deployment. Redox flow batteries (RFBs) have, in some cases, an advantage of decoupled power and energy units, which conceptually resembles the mechanism of PHS where water is used as the low cost working fluid and the power cost is diluted at long-duration storage.

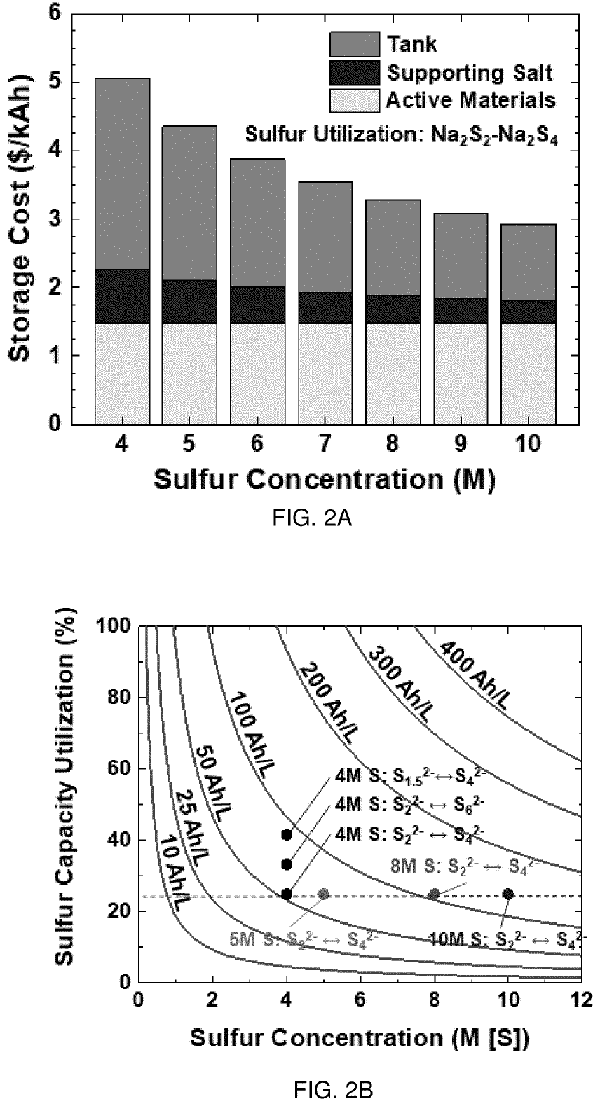

To make RFBs competitive with PHS, it is important to leverage cost-effective energy storage compounds. To this end, aqueous polysulfide electrode is one attractive option for grid storage due to the abundance and ultra-low cost of elemental sulfur (˜$0.25/kg), as well as the high solubility (up to 16M sulfur) of polysulfide in water. Techno-economic analysis indicates that the costs of the auxiliary components required to store the aqueous polysulfide electrolyte is up to twice that of the active materials themselves as shown in FIG. 2A. Therefore, increasing the volumetric capacity (Ah/L) of polysulfide electrodes (e.g., electrolytes comprising polysulfides a redox-active reactants) is an attractive strategy for further reduction of the energy cost. In this regard, several attempts have been made.

To increase the capacity of the aqueous polysulfide electrodes, herein, two strategies were explored: (1) extending the sulfur capacity utilization, and (2) increasing the “effective concentration.” FIG. 2B plots the volumetric capacity contour lines with capacity utilization and sulfur concentration as the independent variables on y and x axes, respectively. The labeled points represents the concentrations and capacity utilizations demonstrated previously (5M S cycled between S₂²⁻ and S₄²⁻ using Li⁺ as the cation) and investigated in this work (other points, using Na⁺ as the cation). Coupling with electrochemical and chemical analyses, the feasibility as well as the electrochemical cycling stability and reversibility will be discussed in detail.

### Results and Discussion

Capacity Fading when Accessing Capacity Utilization Beyond the Range Between Na₂S₂ and Na₂S₄

High chemical stability of aqueous polysulfide electrolyte is important for reversible electrochemical cycling. Previous studies have indicated that polysulfide species in aqueous media decay when cycled beyond the oxidation state of S₄²⁻ and S₂²⁻ range. Two fading mechanisms were proposed: one involving sulfide (S²⁻) taking up protons to release H₂S, and the other involves longer chain polysulfide (S₅²⁻) reacting with hydroxide ion to form thiosulfate (S₂O₃²⁻) as shown in Eqs. 1 and 2, respectively. Both reactions result in capacity fade since H₂S gas are released into the environment, and thiosulfate formation is irreversible. Due to the species involved in the reactions, increasing the pH suppresses H₂S generation by reducing the available protons. The case of thiosulfate formation, however, is more complicated. As pH increases, the chemical equilibrium of polysulfide species favors short-chain polysulfides (i.e. S₄²⁻ or S₂²⁻); therefore, one of the reactant, OH⁻, increases while the other, S₅²⁻, decreases. The kinetics of thiosulfate formation, thus, peaks at some intermediate pH. Calculations by Giggenback indicate that such intermediate pH occurs between pH of 12 and 14 depending on the overall oxidation state and polysulfide concentration in the solutions. At the same time, sulfur redox reaction in aqueous media has a standard electrode potential of ˜−0.45 V vs. standard hydrogen electrode (SHE), which makes high pH important in some cases for preventing hydrogen evolution during electrode oxidation. To reduce the capacity fade associated with the two fading mechanisms, all experiments in this example were conducted with 3M NaOH as the supporting electrolyte.

S²⁻(aq)+2H⁺(aq)→H₂S(g)↑ (Eq. 1)

S₅²⁻(aq)+3 OH⁻(aq)→S₂O₃²⁻(aq)+3 HS⁻(aq) (Eq. 2)

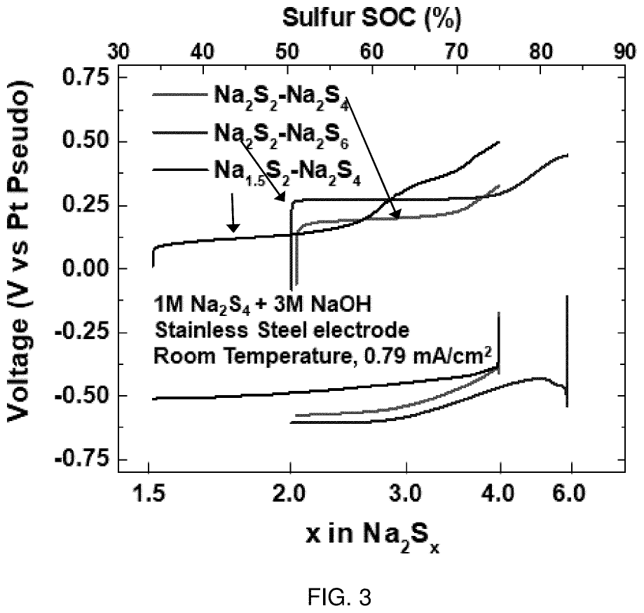

One way to increase the volumetric capacity of the aqueous sulfur electrode is accessing wider range of sulfur capacity, illustrated as the vertical axis in FIG. 2B. To compare the reversibility of aqueous polysulfide electrodes accessing different ranges of sulfur capacity, three cycling experiments with 1M Na₂S₄ equivalent to 4M total sulfur, were conducted with sulfur capacity ranges of Na₂S₂ to Na₂S₄, Na₂S₂ to Na₂S₆, and Na₂S_{1.5} to Na₂S₄, or 25.0%, 33.3%, and 41.7% of sulfur theoretical capacity, respectively, as shown in FIG. 2B. The cycling experiments recorded voltage (versus a Pt pseudo reference electrode) as a function of time. Since the fading mechanisms involve chemical reactions instead of electrochemical decay, the calendar time before observable decay was more relevant than the number of cycles. The cell cycled between Na₂S₂ to Na₂S₄ showed no detectable capacity fading throughout the duration of the experiment, or 600 hours. The other two cells that cycled between wider ranges of capacity, Na₂S₂ to Na₂S₆ and Na₂S_{1.5} to Na₂S₄, however, experienced capacity fading within several hundred hours (at around 450 hours for Na₂S₂ to Na₂S₆ and at around 300 hours for Na₂S_{1.5} to Na₂S₄, respectively) as indicated by the changes in voltage profiles under the oxidation process. The emergences of an additional oxidative voltage plateau in the Na₂S₂ to Na₂S₆ and the Na₂S_{1.5} to Na₂S₄ cycling experiments indicated different reaction schemes beyond the predetermined nominal capacity range, which may involve the formation of other sulfur species. These three experiments indicated that an aqueous sodium polysulfide electrode experiences capacity fading when being cycled to capacity beyond Na₂S₂ and Na₂S₄. Plotted in FIG. 3 is the overlay of 1st cycle voltage profiles of the 3 capacity utilizations. The Na₂S_{1.5} to Na₂S₄ profile clearly includes an additional oxidation plateau (between Na₂S_{1.5} and Na₂S₂) attributed to Na₂S reacting to form sodium polysulfide. On the other hand, Na₂S₂ to Na₂S₆ has an emerging plateau-like feature near Na₂S₆ in both oxidation and reduction voltage profiles.

The results of this example agree with the results of previous studies, in which the presence of S²⁻ and S₅²⁻ triggers H₂S generation and thiosulfate formation, respectively. Many advanced characterization techniques can help elucidate these issues. Previous work utilized optical spectroscopy, electrospray mass spectrometry, and Raman spectroscopy to qualitatively and, to limited extent, quantitatively identify the speciation in aqueous polysulfide solutions with a wide range of compositions and alkali cations such as Li⁺, Na⁺, and K⁺. In addition, a wide range of characterization techniques applicable here including Raman spectroscopy and X-ray absorption spectroscopy (XAS) have been documented. For certain embodiments of aqueous sulfur-based energy storage systems intended for large scale and long duration operation, the aqueous polysulfide electrode must remain in the stable speciation range between Na₂S₂ and Na₂S₄ to avoid capacity fading. Thus, extending the sulfur oxidation states may not be a viable pathway to enhance volumetric capacity of aqueous polysulfide electrodes, in accordance with certain embodiments.

### Example 3

This example describes further experimentation, embodiments, and non-limiting theories regarding the mechanisms and parameters guiding the electrochemical apparatuses, electrolytes, and methods described herein. The materials and parameter values described in this example are non-limiting and by way of example, only.

### Long-Term Cycling of Precipitation Electrode

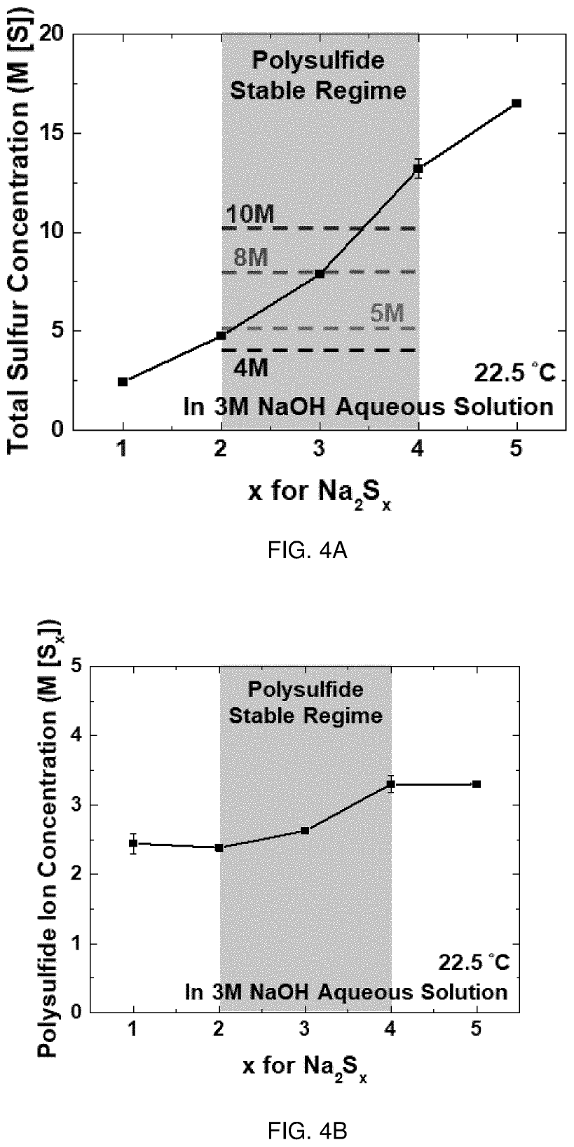

Most electrodes in redox flow batteries remain fully soluble, or defined here as “solution electrode”, throughout the entire charging-discharging cycles. The solubility of redox active species, therefore, often limits the volumetric capacity of RFBs. To gauge the limiting capacity of polysulfide solution electrodes, the solubility limits of sodium polysulfides in various oxidation states were measured and plotted in FIGS. 4A-4B with the shaded areas indicating the stable cycling range. The solubility measured in term of the total dissolved sulfur shown in FIG. 4A increases rapidly as the sulfur chains become longer. The rapid increase is, partly, due to the increasing number of sulfur per polysulfide ion; when plotted with respect to polysulfide ion concentrations, as shown in FIG. 4B, the solubility changes less dramatically. For a solution electrode operating at room temperature, the limiting total sulfur concentration was ˜5 M, as dictated by the solubility of Na₂S₂, corresponding to 67 Ah/L capacity. In contrast, the total sulfur concentration for soluble Na₂S₄ was about 13 M, corresponding to 175 Ah/L capacity.

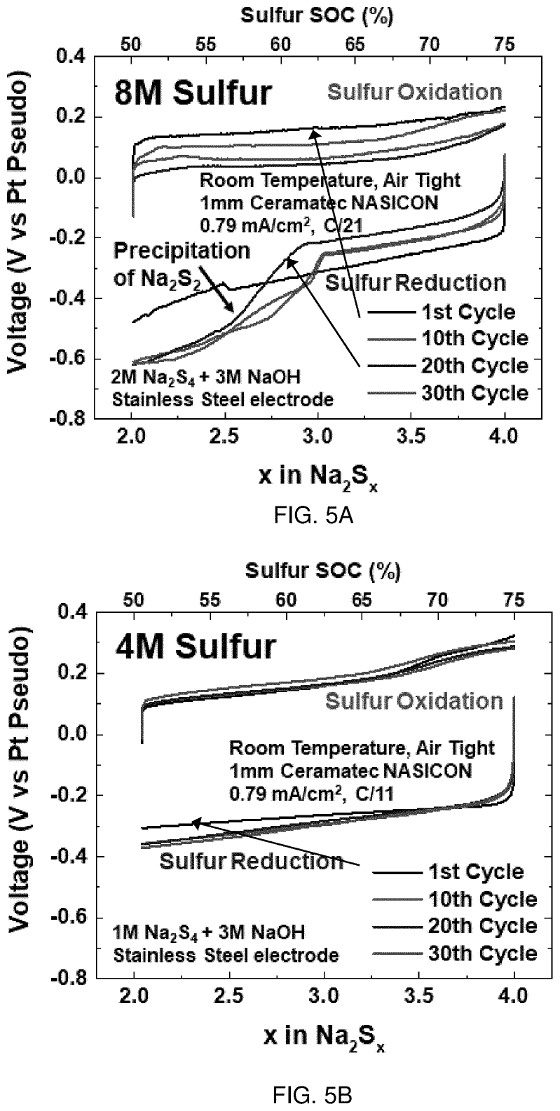

One way to bypass this solubility limitation was to leverage a “precipitation electrode”. Such a strategy provided for higher volumetric capacity by increasing the “effective concentration” illustrated as the x-axis in FIG. 2B. A non-aqueous lithium-sulfur battery, for example, utilizes the full capacity of sulfur by depositing both Li₂S and elemental sulfur, both of which are insoluble in conventional non-aqueous electrolytes. Moreover, in attempt to increase the energy density and lower the storage costs, the idea of “lean” electrolyte, or high electrode-to-electrolyte ratio, in recent years requires sodium polysulfide solids to participate in the redox reactions in Li-S battery. The reversibility of aqueous polysulfide electrolyte was studied at 8 M total sulfur concentration cycled between Na₂S₂ and Na₂S₄ with voltage profile of selected cycles shown in FIG. 5A. For comparison, a 4 M total sulfur concentration electrolyte, which uses solution electrodes (e.g., electrolyte in which a precipitate is not formed during cycling), was also experimented as shown in FIG. 5B. The 4 M sulfur cell exhibited a smooth voltage profile throughout the cycles. The voltage profiles of the 8 M total sulfur cell, however, included a sudden drop during the reduction of Na₂S₄ to form Na₂S₂, indicating the transition between fully soluble and precipitation regimes. Such a sudden drop in voltage, or increase in overpotential, originated from large ohmic resistance induced by the precipitation of insulating sodium polysulfide onto the current collector and inside the electrode. Nevertheless, both electrodes showed highly reversible cycling without any noticeable capacity fading throughout the duration of the experiment, which was remarkably more than 1600 hours in calendar time. The first cycle of the precipitation cell in FIG. 5A behaved differently from the rest of the cycles, with an initial bump and then faster growth afterwards; such deviation may have resulted from the surface modification of the stainless steel current collector as polysulfide redox occurred in the first cycle. The vertical shifting of the voltage profile among cycles may be due to the chemical environment change of the Pt pseudo-reference electrodes. Nevertheless, the cycling results indicate that the aqueous polysulfide electrodes underwent a reversible redox reaction between Na₂S₂ and Na₂S₄ even when the polysulfide species were precipitated and re-dissolved during cycling. The chemical analysis discussed below also demonstrated that the precipitation electrode maintained chemical stability without issues of H₂S generation or thiosulfate formation.

Notably, many other redox chemistries experience similar “unbalanced” solubility between reduced species and oxidized species. For example, in polyiodide I⁻/I₃⁻ redox chemistry, the NaI has solubility as high as 7.8M in aqueous solution, while NaI₃ has a lower solubility of <0.2M. The precipitation electrode approach revealed here for aqueous polysulfide could help other redox chemistry access the otherwise “wasted” solubility and in turn, enhance the capacity density.

### Example 4

### Cost Analysis and Capacity Enhancement of Precipitation Electrodes

For RFBs using polysulfide electrodes, energy cost primarily comes from the auxiliary components including the supporting electrolytes (e.g., NaOH) and tanks to store the active materials. FIG. 2A shows the cost breakdown of different components that contribute to the costs per stored capacity ($/kAh) at different sulfur concentrations. At the solubility limit of Na₂S₂, or 5M sulfur, the combined costs of supporting electrolyte and tank account for ≥60% of the total cost per stored capacity. This suggests that increasing the capacity of such electrodes, which decreases the tank size and supporting electrolyte utilized, may be a viable path toward lowering the energy cost. With increasing volumetric capacity, the active materials costs remain the same; but the combined costs of tank and supporting electrolyte decrease rapidly. As shown in FIG. 2A, the enhancement in capacity results in lowering the costs per stored capacity by 25% (˜$1/Ah) and 30% (˜$1.2/Ah) of the total costs, for 8M cell and 10M cell, respectively, compared to the case of a 5M cell.

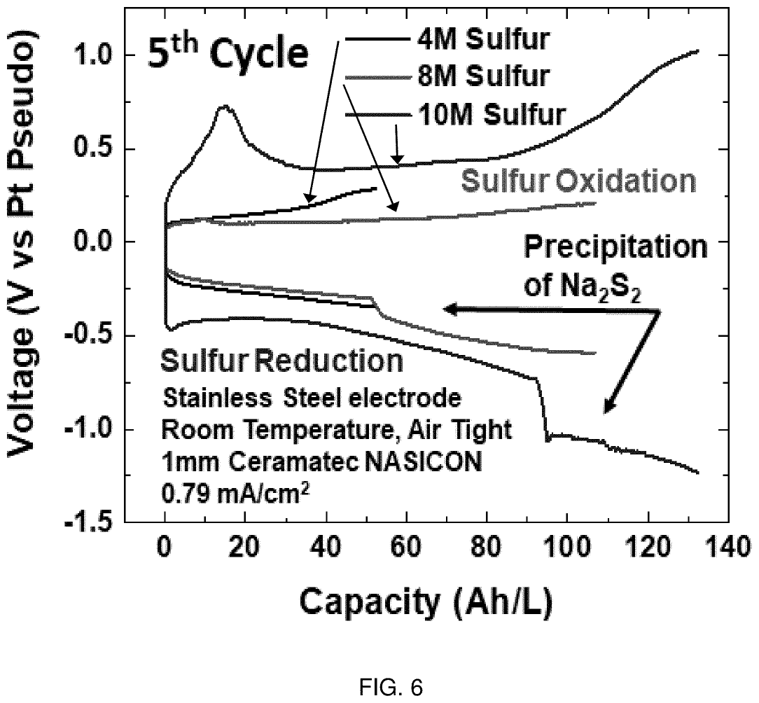

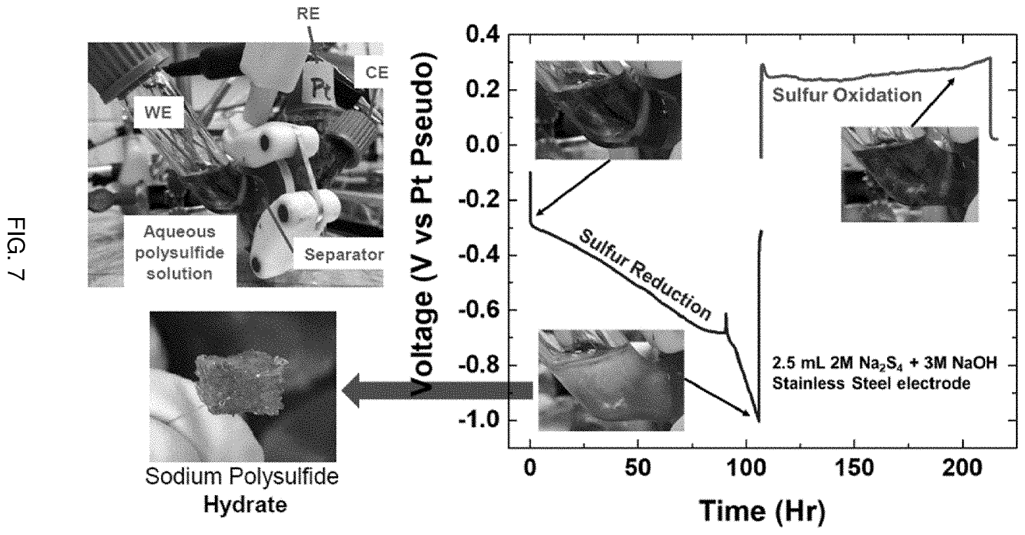

The voltage profiles of 5^{th} cycles of cells with 4M, 8M, and 10M total sulfur concentration and cycled between Na₂S₄ and Na₂S₄ are shown in FIG. 6. Indeed, both the 8M and 10M cells underwent precipitation as indicated by the sudden increase in overpotential during reduction. Because the utilizable concentration for a solution-only electrode is ˜5M sulfur as determined by the solubility limit of Na₂S₂, or 67 Ah/L in capacity, the 8M and 10M cells demonstrated 60% and 100% increases in “effective concentration” and capacity, or 107 Ah/L and 134 Ah/L, respectively, as shown in FIG. 2B. The formation of hydrate precipitates consumed water, which must therefore, in some cases, be present in liquid form to allow for ion transport within the electrolyte. Therefore, the concentration may, in some cases, not be so high such that all water molecules precipitates in the form of the solid hydrates. The voltage profile of 10M cell showed a very large overpotential upon precipitation, indicating the depletion of liquid water; therefore, it is believed, without being bound by any particular theory, that the concentration limitation of precipitation electrode is ˜10 M sulfur.

### Observation of Sodium Polysulfide Precipitates

A straightforward way to confirm the precipitation and re-dissolution mechanism proposed in this example was to directly observe the solid appearance and disappearance in the cell. To carry out this study, a precipitation electrode with 8 M total sulfur was used. One cycle of such a precipitation electrode in the observable cell is shown in FIG. 7. The photos taken of the as-assembled cell, the cell after reduction, and the cell upon the completion of one cycle clearly indicated the appearance and disappearance of solid inside the electrolyte. As-assembled, the polysulfide electrolyte containing 2 M Na₂S₄ had a dark orange color without any sign of non-dissolved solid. After reducing to Na₂S₂, the polysulfide electrolyte contained visible light yellow solids floating in the electrolyte. After being oxidized back to its original state, the polysulfide electrolyte reverted to dark orange color with all the floating solid dissolved. Polysulfide precipitation electrodes may require fast re-dissolution of precipitates upon oxidation to cycle stably. In preparing the polysulfide solutions, it was observed that, even at high concentrations (2.5 M Na₂S₄, or equivalent to 10M total sulfur), the Na₂S and sulfur powders fully dissolved into alkaline solutions typically within 3 hours while stirring.

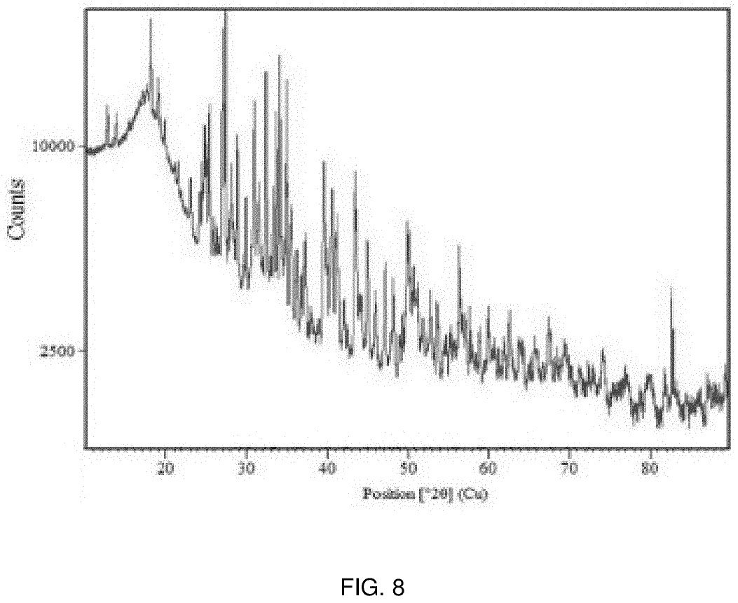

Materials characterization techniques were adopted to understand the precipitation process in aqueous polysulfide electrolytes. SEM images of the precipitates revealed that sodium polysulfide precipitated with high surface area. To further investigate the precipitates, X-Ray Diffraction (XRD) was performed on the dried precipitate powders, which showed sharp crystalline peaks as shown in FIG. 8. Inferring from the excess number of peaks in XRD patterns, it is believed believe that the precipitate composed of multiple crystalline phases.

### X-Ray Photoelectron Spectroscopy of Sodium Polysulfide Precipitates

With the fading mechanisms discussed in Example 2, determining the oxidation state of polysulfide species in solution was important to understand the chemical stability of the polysulfide electrodes as the polysulfide species were, in some cases, only stable within the Na₂S₂ and Na₂S₄ oxidation states. For the precipitation electrodes, the precipitation caused complications in determining the oxidation state of the remaining solutions. To be more specific, the calculated oxidation state is based on the amount of charge applied to the overall oxidation state of the entire electrode, or the average between the precipitates and the remaining solutions. Therefore, to determine whether the solutions remain in stable regions of polysulfide species, the oxidation state of either the precipitates or the solutions needed to be measured. Here, the oxidation state of the precipitates was measured using X-ray photoelectron spectroscopy (XPS).

XPS has been widely used to study sulfur-based compounds in the literature for various applications, in part due to the availability of the binding energy information in different chemical environments for sulfur atoms (separation of about 8 eV from sulfate S⁶⁺ to sulfide S²⁻).

In this Example, two different polysulfide precipitation samples were analyzed using XPS: a fresh sample processed immediately after the reduction step, and a sample aged in the cell for 2 weeks after the electrochemical treatment. Survey spectra of both samples measured at binding energies from 1100 eV to 0 eV included signals from all elements expected including sodium, sulfur, and oxygen along with carbon from surface contamination. Relatively intense oxygen peaks were observed, suggesting that sodium polysulfide in aqueous media likely precipitates to form hydrate crystals, as further confirmed by the absence of sulfate or sulfite signals in the S 2p spectra taken of the two respective samples (focusing on binding energies from 174 eV to 156 eV). S 2p spectra of both samples showed overlapping of multiple S 2p_{3/2}-S 2p_{1/2} doublets. Each doublet contained two peaks constrained to binding energy separation of 1.2 eV and intensity ratio of S 2p_{3/2}:S 2p_{1/2}=2:1. Alkali metal sulfide has sulfur atoms of 3 different chemical environments: sulfide, terminal sulfur, and center sulfur. In this case, the sulfide (Na-S-Na) represents sulfur atoms bonded to 2 sodium atoms (Na₂S), while the terminal sulfur (Na-S-S) and center sulfur (S-S-S) correspond to the sulfur atoms at the end and in the center of the polysulfide chains, respectively. For example, Na₂S₂ contains 2 terminal sulfur atoms, while Na₂S₄ contains 2 terminal sulfur atoms and 2 center sulfur atoms. Table 1 summarizes the binding energy and full width at half maximum (FWHM) for the S 2p_{3/2} peak as well as the atomic percent for sulfur of different chemical environments of both samples. For the fresh sample, three doublets were identified with S 2p_{3/2} binding energy at 160.0 eV, 161.7 eV, and 163.3 eV, and were assigned to sulfide, terminal sulfur, and central sulfur, respectively. On the other hand, the 2p_{3/2} peaks of the aged sample doublets are 160.0 eV, 161.8 eV, and 163.3 eV. Both peak positions and FWHMs agreed reasonably well with values reported in the literature. The atomic percentage of sulfur with different chemical compositions was calculated using the ratio of areas under the doublets. The fresh sample, therefore, contained 0.93% sulfide, 80.49% terminal sulfur, and 18.48% center sulfur, while the aged sample contains 7.48% sulfide, 67.46% terminal sulfur, and 25.06% center sulfur. Table 2 summarizes the average oxidation state of sulfur in the fresh and in the aged sodium polysulfide precipitation samples.

TABLE 1
S 2p_{3/2} peak positions, FWHMs, and atomic percent of sulfide (Na—S—Na),
terminal sulfur (Na—S—S), and center sulfur (S—S—S)
in both fresh and aged sodium polysulfide precipitation samples.

| | | | Terminal | |
|---|---|---|---|---|
| | | Sulfide | Sulfur | Center Sulfur |
| | | (Na—S—Na) | (Na—S—S) | (S—S—S) |
| Fresh | S 2p_{3/2} Position (eV) | 160.0 | 161.7 | 163.3 |
| precipitation | S 2p_{3/2} FWHM (eV) | 1.00 | 1.06 | 1.35 |
| sample | Atomic % | 0.93 | 80.49 | 18.48 |
| Aged | S 2p_{3/2} Position (eV) | 160.0 | 161.8 | 163.3 |
| precipitation | S 2p_{3/2} FWHM (eV) | 0.94 | 1.42 | 1.17 |
| sample | Atomic % | 7.48 | 67.46 | 25.06 |

TABLE 2
Average oxidation states of sulfur in both fresh and
aged sodium polysulfide precipitation samples.

| | Average Oxidation State |
|---|---|
| Fresh precipitation sample | −0.824, Na₂S_{2.43} |
| Aged precipitation sample | −0.824, Na₂S_{2.43} |

The atomic percents from the S 2p did not provide enough information to quantify the different species present in the precipitates, but two conclusions could be drawn, without being bound by any particular theory. First, assuming that Na₂S₃ was not present in aqueous system as previous literature have claimed, at least 62% of sulfur atoms in the fresh precipitates occur in the form of Na₂S₂. In most extreme case, all polysulfides take the form of either Na₂S₂ and Na₂S₄, and since there is only 18.48% of center sulfur, Na₂S₄ contain 36.96% of sulfur leaving 62.01% of sulfur to Na₂S₂. Moreover, the presence of longer chain polysulfides push this 62.01% to a higher value. Therefore, the fresh precipitates were predominantly Na₂S₂. Second, the atomic percents allowed for calculation of average oxidation state of the precipitates. Sulfide (Na-S-Na), bounded to 2 sodium atoms, takes the oxidation state of −2, terminal sulfur (Na-S-S), bounded to 1 sodium atom, contributes to the calculation by −1, and center sulfur (S-S-S) gives 0 since it does not bond any sodium atom. The average oxidation states, thus, yield −0.824, or Na₂S_{2.43}, nominally, for both samples. One possible explanation for higher oxidation states than that of S₂²⁻, or −1, is that at the early stage of precipitation, the average oxidation state of the polysulfide species was still higher than −1; longer chain polysulfide was precipitated. Nevertheless, this analysis indicated that both the precipitates and the remaining solutions have oxidation states fairly close to that of Na₂S₂. Also considering the charge transferred in the electrode during the cycling, it is safe to draw the conclusion that the electrolytes of the precipitation electrodes stay in the stable oxidation states between Na₂S₄ and Na₂S₂. Comparison between the S 2p spectra of the two samples also reveals that although the average oxidation states are almost identical, the sample aged for 2 weeks has lower percentage of terminal sulfur, but higher percentage of sulfide and center sulfur. This likely suggests that the sodium polysulfide in the precipitates disproportionates into a small amount of sodium sulfide and longer chain polysulfide. However, the stable average oxidation state seems to indicate that such decomposition reaction does not trigger the two fading mechanisms mentioned earlier since loss of either Na₂S or Na₂S₅ would change the average oxidation state.

### Precipitation Electrodes Subjected to Aging and Various C-Rates

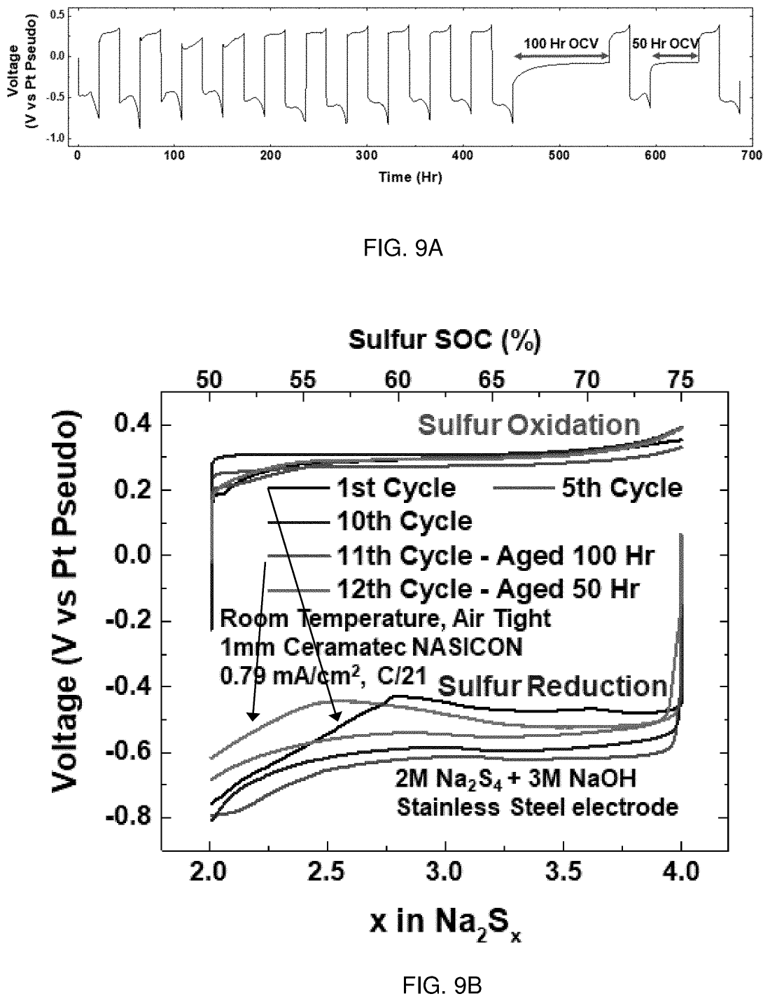

A cycling experiment was performed with aging after precipitation occurred during the reduction steps in the aqueous polysulfide electrolyte. The cell was allowed to rest for 100 hours at open circuit potential after 10 continuous cycles and before starting the 11th cycle, and then allowed to rest for 50 hours of open circuit before starting the 12th cycle as shown in FIG. 9A. Voltage profiles of selected cycles are then plotted in FIG. 9B with respect to sulfur oxidation state. The oxidative voltage profiles of aged cycles overlapped almost identically with the that of earlier cycles with the exception of the early stage of oxidation, where aged cycles exhibit lower voltage than the 10th cycle (no aging). Such a difference in voltage profile may, without being bound by any particular theory, result from the presence of solid sodium sulfide, which has a lower redox potential than polysulfides, in the aged precipitates. The identical voltage except for the 1st cycle and the absence of additional voltage plateau that were observed the cycling experiments involving Na₂S₂ to Na₂S₆ and the Na₂S_{1.5} to Na₂S₄ in Example 2 indicated that no noticeable capacity fading originated from the precipitate agings, consistent with the sulfur oxidation states in XPS analysis between fresh and aged samples. This seemed contradictory to the earlier observation that the presence of Na₂S and long chain polysulfide led to capacity fading via H₂S generation and thiosulfate formation in Example 2. However, the decaying mechanism mainly occurred with the sulfur species dissolved in solution; the precipitated sodium polysulfides, on the other hand, did not interact with the ions in solutions to cause detectable loss of active materials even after total of 150 hours of aging. This result showed the promising application of such precipitate electrode in grid-scale storage where the electrodes may be driven to precipitation and be maintained in that condition for a long period of time before the reversed operation is needed.

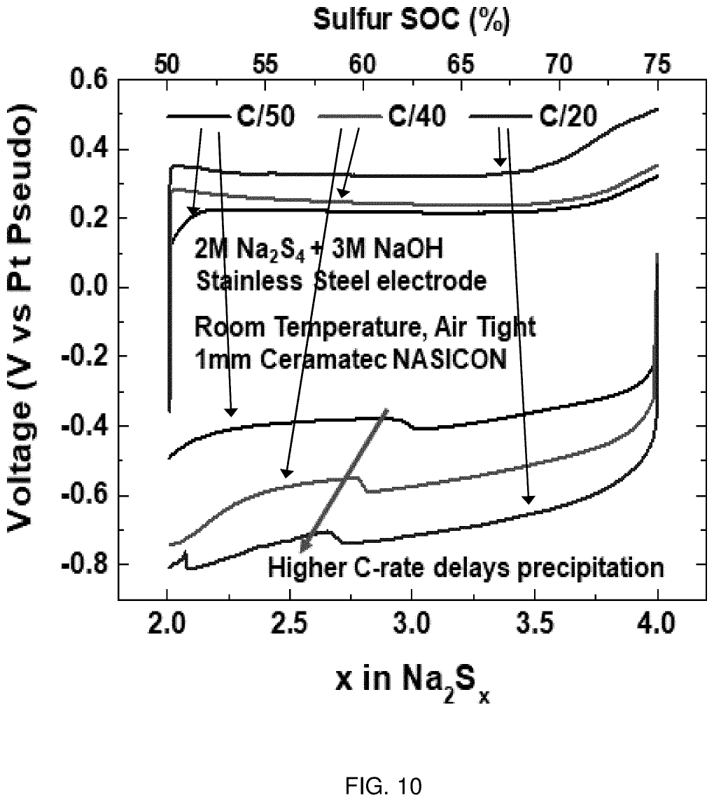

Whether the rate condition influenced the precipitation behavior, due, for example kinetics governing the nucleation process during the discharge (reduction) process, was examined. Higher C-rate postponed the occurrence of precipitation because the polysulfide species had less time to form the nucleation clusters of sufficient size. FIG. 10 shows the voltage profiles of a precipitation electrode under C/50, C/40, and C/20 cycling rates. All oxidative voltage profiles showed an initial bump and then growth of overpotential resembling the first cycle in the cycling experiment as shown in FIG. 5A, where precipitation occurs in the electrolyte. Thus, here, the position of the bump to track the initial formation of precipitates was used. The position of the bump shifted toward more reduced states at higher C-rate, as illustrated by the red arrow in FIG. 10, where more Na₂S₂ was formed. This indicated that higher C-rate might provide for a higher degree of supersaturation of the electrolyte.

### Conclusion

In this example it was demonstrated that a highly concentrated aqueous polysulfide electrode containing up to 10M total sulfur is a promising candidate for RFBs in grid-scale storage. Since such a concentration exceeds the solubility limit of Na₂S₂, the aqueous polysulfide precipitation electrode underwent precipitation and re-dissolution of sodium polysulfide hydrates during reduction and oxidation, respectively. Both cycling experiments of more than 1600 hours and XPS analysis indicated that these polysulfide electrolytes maintained chemical and electrochemical stability throughout the experiments when cycled between Na₂S₂ and Na₂S₄. Another finding of these examples was that, in some cases, it may be beneficial for the capacity utilization range to remain within Na₂S₂ and Na₂S₄, or 25% total sulfur capacity, to prevent capacity fade as a result of H₂S generation and thiosulfate formation. In addition, the stability of the precipitation electrodes were examined in a precipitate aging study and C-rate study. The electrodes underwent these conditions maintained high stability and exhibited consistent precipitation behavior. These results indicated the reversibility and durability of the aqueous polysulfide electrode, which are important characteristics of grid-scale storage, as well as demonstrated a unexpected but attractive approach to enhance capacity for redox chemistries with unbalanced solubilities between oxidized and reduced states. In comparison with conventional polysulfide solution electrode used in most aqueous sulfur-based RFBs, highly concentrated electrodes and electrolytes, such as those described herein, may, in some embodiments, reduce the costs of capacity storage by 30%.

### Example 5

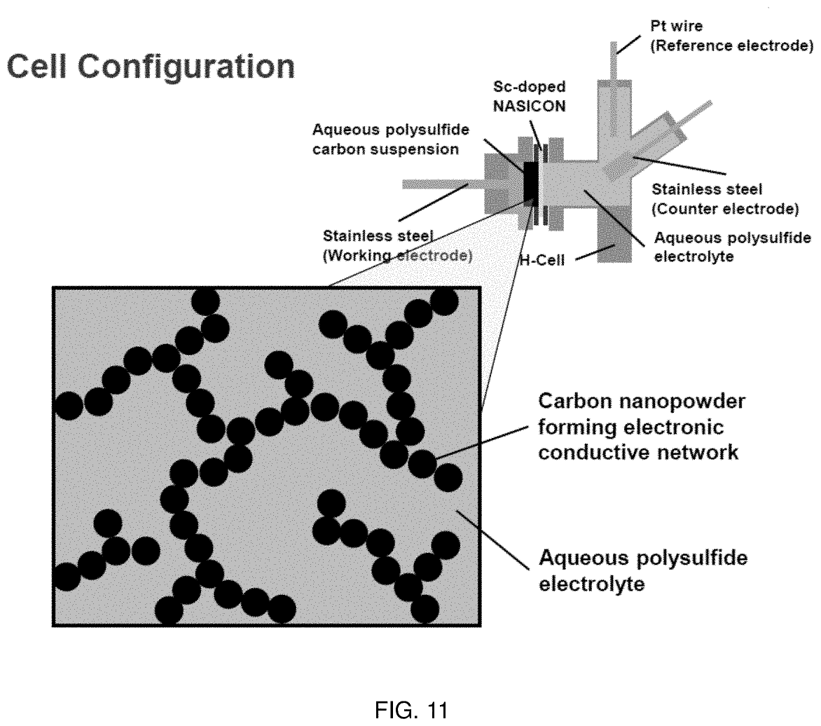

It was observed that a higher C-rate resulted in larger overpotential, which may, in some cases, affect the efficiency. In the previous examples, a stainless steel current collector, which is a highly stable conductor in aqueous polysulfide solution, was used to prevent capacity fading associated with side reactions. However, stainless steel exhibits poor catalytic activity for polysulfide redox reactions, giving rise to relatively high overpotentials in all cycling experiment presented in the examples above. This example explores, instead, the use of a conductive nanopowder suspension to reduce energy inefficiency. The electronic conductivity of solutions of varying conductive carbon nanopowder content, with the solutions containing 2M Na₂S₄ and 3M NaOH, were measured. It was observed that increased loading of carbon led to increased electronic conductivity of solutions. For example, a solution with 1 volume percent (vol %) carbon content (from the carbon nanopowder) had an electronic conductivity of around 1 mS/cm, while a solution with 2 vol % carbon content had an electronic conductivity of around 3 mS/cm, and a solution with 4 vol % carbon content had an electronic conductivity of around 8-12 mS/cm. The carbon nanopowder was Vulcan XC 72R, and was mixed with the solution and sonicated overnight to form the suspension of conductive particles. The measurements were taken using a cylindrical Swagelok Cell in which the carbon suspension electrode was directly between two stainless steel electrodes. FIG. 11 shows a schematic illustration of an exemplary electrochemical apparatus with a carbon suspension, with a zoomed in view of a percolation conductive network in the electrolyte.

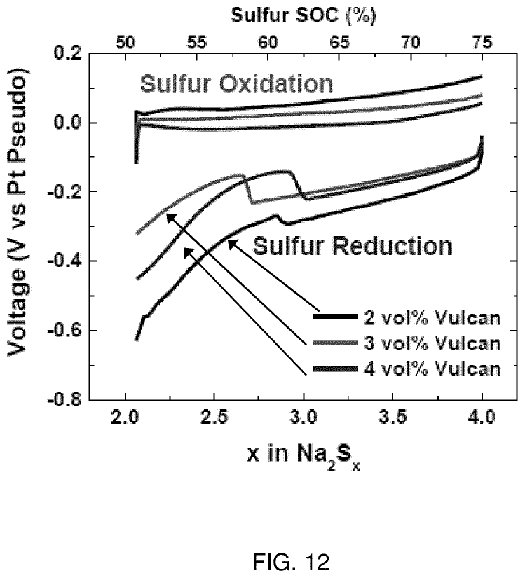

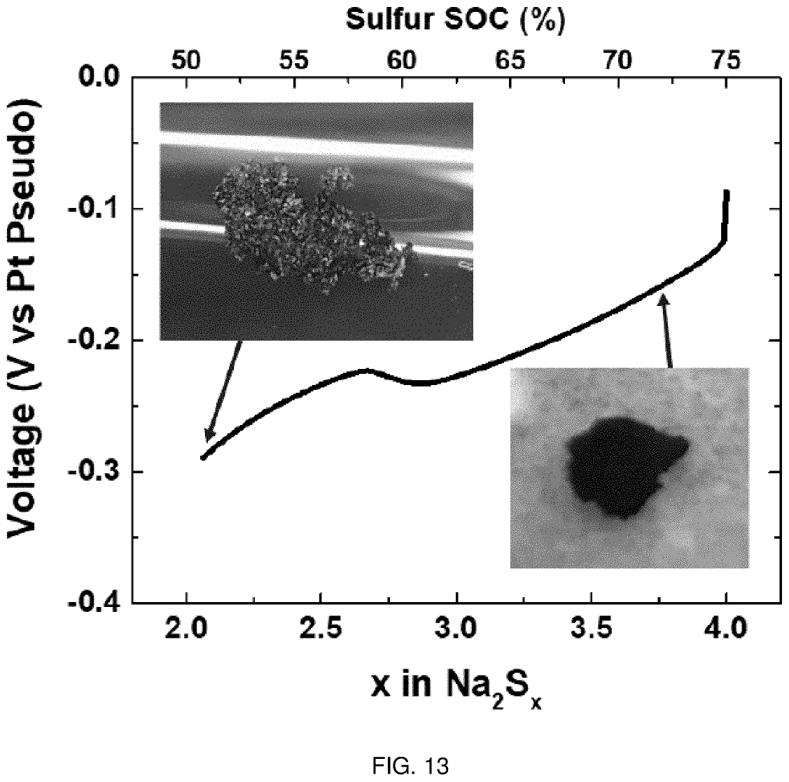

Cycling results of electrolytes containing 2M Na₂S₄ and 3M NaOH with various amounts of Vulcan carbon in the suspensions were acquired. Cycling with 0 vol % carbon suspension, with that solution having a measured area-specific resistivity (ASR) of 217 ohms/cm², and cycling with 3 vol % carbon suspension, with that solution having an ASR of only 60 ohms/cm², demonstrated a roughly 2.5 times decrease in overpotential due to the presence of the conductive carbon suspension in the electrolyte. Additionally, a 2.5 times enhancement in current density (0.79 mA/cm²) vs. (1.97 mA/cm²) was observed in going from 0 vol % to 3 vol % carbon conductive powder. FIG. 12 shows cycling data for the same composition electrolyte solution at varying loadings of carbon conductive powder. FIG. 13 shows images of conductive nanopowder collected at varying points in a cycling experiment. The powder imaged following precipitation shows direct evidence of precipitation of polysulfide on to the carbon itself.

### Example 6

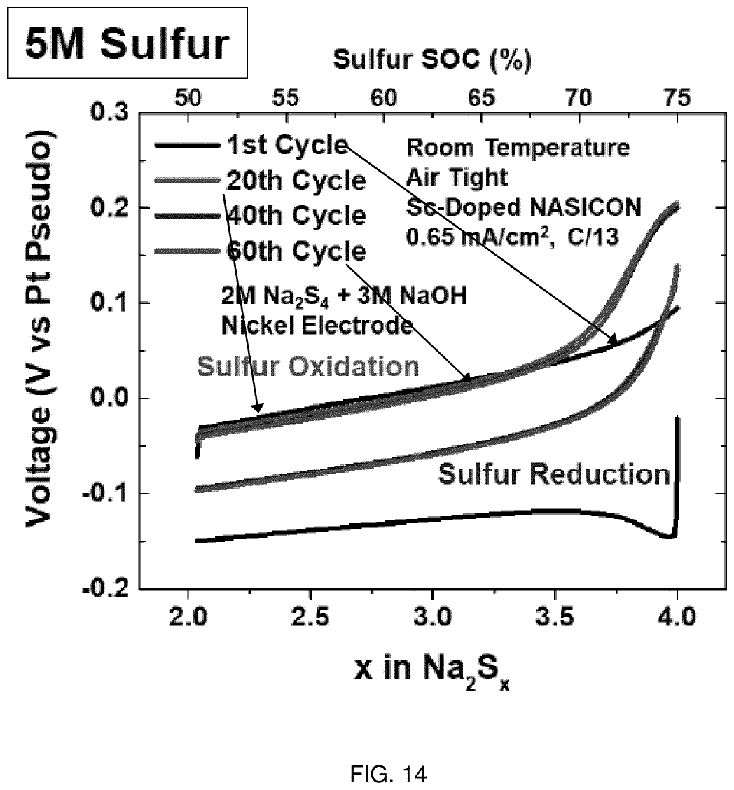

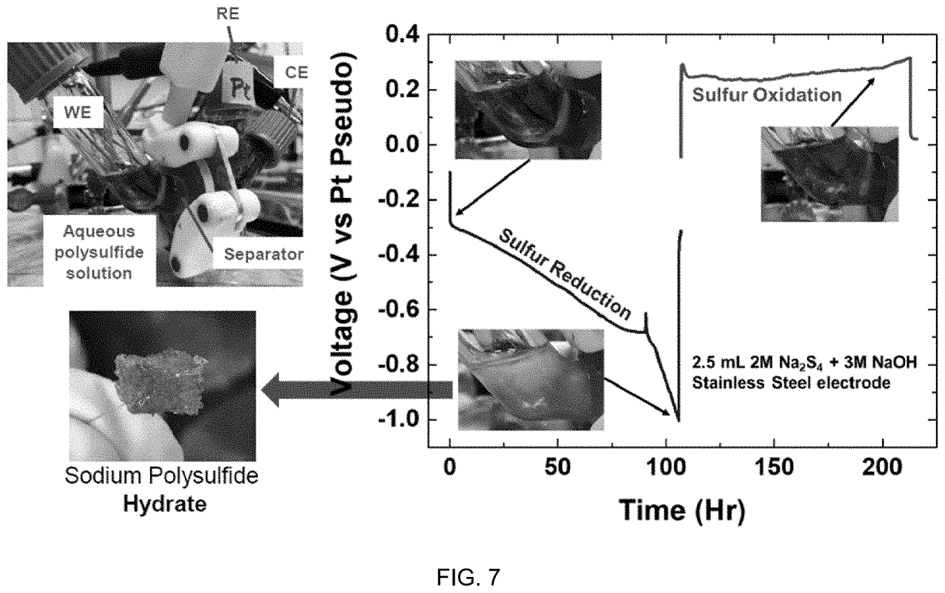

This example shows experimentation for an electrocatalysis approach to reducing overpotential. In particular, a nickel electrode was used as an electrode with an electrolyte solution containing 2 M Na₂S₄ and 3 M NaOH. A nickel sulfide electrocatalyst formed during cycling. FIG. 14 shows the cycling under such conditions. A bulk overpotential of 70 mV (not corrected for Ohmic compensation) was observed, with 39 mV of the overpotential being attributed to the NASICON separator. This example demonstrates that with a transition metal electrocatalyst electrode, a redox round trip for polysulfide can have an overpotential as low as even 30 mV.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electrochemical apparatus comprising:
a first electrolyte comprising a liquid solvent and a redox-active reactant, the redox-active reactant having a reduced state and an oxidized state and comprising an active species;
wherein solubility of the redox-active reactant in the reduced state, and solubility of the redox-active reactant in the oxidized state are each greater than or equal to 0.1 M in the first electrolyte at 22.5° C., and
wherein during a charging process and/or a discharging process of the electrochemical apparatus that causes interconversion between the reduced state and the oxidized state of the redox-active reactant, at least 10 mole percent of the active species in the first electrolyte is present as a solid.

2. The electrochemical apparatus of claim 1, wherein the liquid solvent is an aqueous solvent.

3. The electrochemical apparatus of claim 1, wherein the total concentration of active species in the first electrolyte is greater than or equal to 0.5 M.

4. The electrochemical apparatus of claim 1, wherein greater than or equal to 20 mole percent of the active species is present in the first electrolyte as a solid during the charging process and/or the discharging process.

5. The electrochemical apparatus of claim 1, wherein less than or equal to 90 mole percent of the active species is dissolved in the solvent of the first electrolyte during the charging process and/or the discharging process.

6. The electrochemical apparatus of claim 1, wherein the electrochemical apparatus can be charged and discharged reversibly.

7. The electrochemical apparatus of claim 1, wherein the first electrolyte is an anolyte.

8. The electrochemical apparatus of claim 1, wherein the first electrolyte is a catholyte.

9. The electrochemical apparatus of claim 1, wherein the redox-active reactant comprises a sulfur-containing compound.

10. The electrochemical apparatus of claim 1, wherein the redox-active reactant comprises a polysulfide.

11. The electrochemical apparatus of claim 1, wherein the reduced state of the redox-active reactant comprises S₂²⁻ or a salt thereof, and the oxidized state of the redox-active reactant comprises S₄²⁻ or a salt thereof.

12. The electrochemical apparatus of claim 1, wherein the active species of the redox-active reactant is sulfur.

13. The electrochemical apparatus of claim 1, wherein the redox-active reactant comprises vanadium, iodine, titanium, chromium, manganese, and/or iron.

14. (canceled)

15. The electrochemical apparatus of claim 1, wherein the solid is a nonmetallic compound.

16. The electrochemical apparatus of claim 1, wherein the solid is an electronically insulating compound.

17. The electrochemical apparatus of claim 1, further comprising a first electrode in contact with the first electrolyte.

18. The electrochemical apparatus of claim 1, wherein the first electrode comprises a suspension of conductive particles, optionally comprising carbon.

19-25. (canceled)

26. The electrochemical apparatus of claim 1, wherein the electrochemical apparatus is configured to operate as a flow battery cell.

27-34. (canceled)

35. A method of operating an electrochemical flow cell, comprising
charging and/or discharging the electrochemical flow cell, wherein the electrochemical flow cell comprises a first electrolyte comprising an aqueous solvent and a redox-active reactant, and wherein a portion, but not all of the redox-active reactant is present as a precipitate during at least a portion of either the charging or the discharging.

36-40. (canceled)

41. A method, comprising:
cycling an electrochemical apparatus having a cell potential of at least 0.35 V and a charge capacity of at least 70 Ah/L for at least 100 charge/discharge cycles, wherein the electrochemical cell comprises a redox-active reactant,
and wherein a portion, but not all of the redox-active reactant is present as a precipitate during at least a portion of either the charging or the discharging.
